(19) United States
(12) Patent Application Publication
(10) Pub. No.: US 2026/0178354 A1
(43) Pub. Date: Jun. 25, 2026

(54) APPARATUSES, COMPUTER-IMPLEMENTED METHODS, AND SYSTEMS FOR OUTPUTTING AN EMBEDDED APPLICATION ACCESS SHARE INTERFACE COMPONENT

(71) Applicant: ATLASSIAN PTY LTD., Sydney (AU)

(72) Inventors: Howard Ho Wai Ng, San Leandro, CA (US); Elsie Ruoxi Wang, New York, NY (US); Hannah Josephine Tam, Seattle, WA (US)

(21) Appl. No.: 19/000,880

(22) Filed: Dec. 24, 2024

(51) Int. Cl. G06F 9/451; G06F 16/24; G06Q 10/10

(52) U.S. Cl. CPC G06F 9/451; G06F 16/24; G06Q 10/103

(57) ABSTRACT

Methods, apparatuses, systems, and computer program products are disclosed for outputting embedded application access share interface component(s), in a project management and collaboration system. In an example embodiment, an apparatus receives an embedded application access share request in response to user interaction with an embedded application user interface displayed in association with a user-accessed application, accesses at least a user-accessed application team member repository, determines a member share suggestion set comprising one or more user-accessed application member objects, generates an embedded application access share interface component comprising the member share suggestion set and outputs the embedded application access share interface component for rendering to the embedded application user interface.

### CROSS REFERENCE TO RELATED APPLICATION

This application is related to commonly-owned U.S. Pat. No. 11,044,348, filed on Nov. 5, 2020, as U.S. patent application Ser. No. 17/090,648, and is entitled “SYSTEM, METHOD, AND COMPUTER PROGRAM PRODUCT FOR IMPROVED EMBEDDED APPLICATION DATA MANAGEMENT,” which patent is incorporated by reference herein in its entirety.

### TECHNOLOGICAL FIELD

Embodiments of the present disclosure generally relate to an improved framework for supporting data interoperability between software applications, and specifically to outputting an embedded application access share interface component for rendering to an embedded application user interface displayed in association with a user-accessed application.

### BACKGROUND

Various methods, apparatuses, and systems provide tools for users to plan, coordinate, track, manage, collaborate, and/or otherwise monitor projects and tasks in project management and collaboration systems. Applicant has identified a number of deficiencies and problems associated with efficiently sharing information to other collaborators from a discrete software application embedded within another software application due to product access share barriers. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

In general, embodiments of the present disclosure provided herein include improved methods, apparatuses, systems, computer program products, and/or the like configured for effectively and efficiently outputting embedded application access share interface component(s), in a project management and collaboration system. In accordance with one exemplary embodiment of the present disclosure, an apparatus is provided for outputting an embedded application access share interface component in a project management and collaboration system. The apparatus comprises at least one processor, and at least one memory including program code, the at least one memory and the program code configured to, with the at least one processor, cause the apparatus to receive an embedded application access share request in response to user interaction with an embedded application user interface displayed in association with a user-accessed application, access at least a user-accessed application team member repository, determine, via the at least one processor, a member share suggestion set comprising one or more user-accessed application member objects, generate an embedded application access share interface component comprising the member share suggestion set and output the embedded application access share interface component for rendering to the embedded application user interface. The embedded application user interface corresponds to an embedded application embedded in the user-accessed application.

In some embodiments, the embedded application access share request comprises one or more identifiers associated with the user-accessed application. In some further embodiments, the one or more identifiers comprises at least one of a project identifier, a team identifier, or a team member identifier.

In some embodiments, determining the member share suggestion set comprises generating a query based on at least one of the one or more identifiers associated with the user-accessed application; submitting the query to the user-accessed application team member repository; and assigning the one or more user-accessed application member objects returned by the query to the member share suggestion set. In some further embodiments, determining the member share suggestion set further comprises generating a second query based on at least one identifier associated with the embedded application; submitting the second query to an embedded application member repository; and assigning one or more embedded application member objects returned by the query to the member share suggestion set.

In some embodiments, the user-accessed application and the embedded application define separate executable code bases. In certain embodiments, the user-accessed application defines a first executable code base that performs a particular first set of functions and is configured to provide a second set of functions associated with the embedded application embodied by a second executable code base.

In some embodiments, the at least one memory and the program code are further configured to, with the at least one processor, cause the apparatus to at least receive one or more user-accessed application member object selections; generate an updated embedded application access share interface component removing the member share suggestion set and causing display of the one or more selected user-accessed application member objects; and output the updated embedded application access share interface component for rendering to the embedded application user interface. In some further embodiments, the at least one memory and the program code are further configured to, with the at least one processor, cause the apparatus to at least programmatically generate and transmit an electronic communication to one or more client devices, each client devices associated with a user corresponding to at least one of the one or more selected user-accessed application member objects.

In some embodiments, at least one of the one or more user-accessed application member objects is caused to be rendered in association with an embedded application invitation.

In some embodiments, at least one of the one or more user-accessed application member objects is caused to be rendered in association with an information icon. In some further embodiments, the at least one memory and the program code are further configured to, with the at least one processor, cause the apparatus to at least receive a hover user interaction corresponding to the information icon; and output an informational interface component configured to be rendered to the embedded application access share interface component in association with the information icon, the informational interface component comprising product or software application source data for the corresponding user-accessed application member object.

In another embodiment, a computer-implemented method for outputting an embedded application access share interface component in a project management and collaboration system is disclosed, the method comprising receiving an embedded application access share request in response to user interaction with an embedded application user interface displayed in association with a user-accessed application, the embedded application user interface corresponding to an embedded application embedded in the user-accessed application, wherein the user-accessed application and the embedded application define separate executable code bases; accessing at least a user-accessed application team member repository; determining a member share suggestion set comprising one or more user-accessed application member objects; generating an embedded application access share interface component comprising the member share suggestion set; and outputting the embedded application access share interface component for rendering to the embedded application user interface. In some further embodiments, the embedded application access share request comprises one or more identifiers associated with the user-accessed application. In certain embodiments, the one or more identifiers comprises at least one of a project identifier, a team identifier, or a team member identifier.

In some embodiments, determining the member share suggestion set comprises generating a query based on at least one of the one or more identifiers associated with the user-accessed application; submitting the query to the user-accessed application team member repository; and assigning the one or more user-accessed application member objects returned by the query to the member share suggestion set. In some further embodiments, determining the member share suggestion set further comprises generating a second query based on at least one identifier associated with the embedded application; submitting the second query to an embedded application member repository; and assigning one or more embedded application member objects returned by the query to the member share suggestion set.

In some embodiments, the user-accessed application defines a first executable code base that performs a particular first set of functions and is configured to provide a second set of functions associated with the embedded application embodied by a second executable code base.

In some embodiments, the method further comprise receiving one or more user-accessed application member object selections; generating an updated embedded application access share interface component removing the member share suggestion set and causing display of the one or more selected user-accessed application member objects; and outputting the updated embedded application access share interface component for rendering to the embedded application user interface.

In another embodiment, a computer program product is disclosed, the computer program product stored on a non-transitory computer readable storage medium, comprising instructions that when executed by one or more processors, cause the one or more processors to receive an embedded application access share request in response to user interaction with an embedded application user interface displayed in association with a user-accessed application, the embedded application user interface corresponding to an embedded application embedded in the user-accessed application, wherein the embedded application access share request comprises one or more identifiers associated with the user-accessed application; access at least a user-accessed application team member repository, based at least in part on the one or more identifiers associated with the user-accessed application; determine a member share suggestion set comprising one or more user-accessed application member objects; generate an embedded application access share interface component comprising the member share suggestion set; and output the embedded application access share interface component for rendering to the embedded application user interface.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE SEVERAL VIEWS OF THE DRAWINGS

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the drawings:

FIG. 1 illustrates an example project management and collaboration system configured to communicate with various client devices in accordance with various example embodiments described herein;

FIG. 2 is a schematic block diagram of example circuitry to perform various operations in accordance with various embodiments of the subject disclosure;

FIGS. 3A and 3B illustrate example embedded application access share interface components structured in accordance with example embodiments of the subject disclosure;

FIG. 4A is a flowchart illustrating example operations for outputting an embedded application access share interface component in accordance with various aspects and embodiments of the subject disclosure; and

FIG. 4B is a signal diagram of an example data flow in accordance with various aspects and embodiments of the subject disclosure.

### DETAILED DESCRIPTION

One or more embodiments now will be more fully described with reference to the accompanying drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard). It should be understood that some, but not all embodiments are shown and described herein. Indeed, the embodiments may be embodied in many different forms, and accordingly this disclosure should not be construed as limited to the embodiments set forth herein. Rather, these embodiments are provided so that this disclosure will satisfy applicable legal requirements. As used herein, the description may refer to a server or client device as an example “apparatus.” However, elements of the apparatus described herein may be equally applicable to the claimed system, method, and computer program product. Accordingly, use of any such terms should not be taken to limit the spirit and scope of embodiments of the present disclosure.

### Overview

Methods, apparatuses, systems, and computer program products are provided in accordance with example embodiments of the present disclosure in order to address technical problems associated with generating and providing an improved embedded application access share interface component to an embedded application interface displayed in association with a user-accessed application in, for example, a project management and collaboration system.

Individuals and organizations routinely use a project management and collaboration system to enable an individual user or group(s) of users to plan, track, organize, schedule, collaborate, and/or otherwise manage one or more development projects, such as agile software development projects. Certain software applications in a project management and collaboration system may be developed to enable interaction(s) and/or data interoperability with other software applications. For example, a first software application may be designed to call, or retrieve data from, a second software application to accomplish various tasks or operations in a project management and collaboration system. Such interaction(s) are especially useful in circumstances where the first software application and the second software application have a common owner, are provided in a common software suite or tool kit, and/or otherwise where use of the second software application is to be incentivized.

Conventional “siloing” of software applications, however, can continue to create user experience issues and technical challenges with efforts to achieve true interoperability and seamlessly share content with other users across such software applications, even in instances of embedded applications. For example, interoperability-based technical problems may arise based on the use of particular mechanisms for facilitating communication between the two discrete software applications. Moreover, although access to a second software application may be embedded within a user interface associated with a first software application or “parent” or “host” product, a user may perceive user experience issues associated with sharing content of such second software application with other users due to product access share barriers, particularly when a user search feature associated with a share modal for sharing such content only returns users associated with the second software application. In some instances, when a non-user or non-licensee of the second software application is identified in the share modal for an embedded application, conventional systems may require the user to invite the non-user or non-licensee of the second software application to join or otherwise become a second software application user by manually entering or copying and pasting an email address for the non-user or non-licensee of the second software application.

For example, a user's closest collaborators may be teammates or other members associated with the first software application or “parent” or “host” product, however, such teammates or other members may not yet be associated with, or otherwise be existing users of, the second software application. Technical challenges may arise in such instances due to dedicated and distinct data repositories for each application. For example, information associated with the embedded, second software application may only be directly shared with users already associated with the second software application in some instances or otherwise a context switch is required to share such information with non-users of the second software application. In another example, a context switch may require the user to go “out-of-product” of the first and second software applications, such as to find an email address for their first software application teammate and paste such email address into the share modal or otherwise manually enter contact information for the intended recipient into the share modal in order to share content of the second software application. In another example, a context switch may require the user to copy a link associated with the information of the embedded, second software application and go “out-of-product” of the first and second software applications to paste the link into a separate communication application (e.g., email application, channel-based communication system, or other communication application). Such tedious requirements may lead to a diminished user experience, diminished user device operation efficiency (e.g., given the high incidence of launched, but not shared, second software application sessions), and/or otherwise result in the user simply skipping sharing of such content and, in turn, reduced collaboration. Accordingly, the inventors have determined it would be desirable and advantageous for users of a user-accessed application to be able to share content of an embedded application with other users that are not users of the embedded application but may be a user of the user-accessed application without requiring the user to go “out-of-product” or otherwise “context switch”.

Embodiments of the present disclosure address the various deficiencies set forth above and others described herein. In some embodiments of the present disclosure, a user-accessed application (e.g., Jira Software® (JSW) by Atlassian, Jira Service Management® (JSM) by Atlassian, Jira Work Management® (JWM) by Atlassian, Trello® by Atlassian, etc.) is provided including or otherwise associated with an embedded application (e.g., Confluence® by Atlassian) with which the user-accessed application may interact. A data-driven connection is established and/or otherwise associated with the user-accessed application that enables interoperability between the user-accessed application and the embedded application. In this regard, in some embodiments, the data-driven connection enables functionality of the embedded application to be performed via the user-accessed application. The user-accessed application operates as a back-end and is hosted by a server. The user-accessed application is configured to communicate with and otherwise support a user-facing application (e.g., a client-side app) that operates as a front-end at the client or user device. In various embodiments, a user may access functionality of both the user-accessed application and the embedded application via a single point of interaction (i.e., via the user-facing application launched at the client).

Consider a JSW user who desires to share an embedded Confluence page with one or more other JSW users without leaving the JSW instance. For example, Andy, who works as a software developer for developing a particular software tool, Beta Accounting Software (“Beta”), is associated with a user account for JSW by Atlassian. At least some functionality of an embedded application (e.g., Confluence®) is made accessible from within JSW. In this regard, certain functionality and features of Confluence® are “embedded” within the JSW instance made available to Andy. In one embodiment, JSW is configured to provide access to certain Confluence® content collaboration functionality, such as creating new pages, updating page content, and/or sharing page content. Such functionality is powered by Confluence® but made available all from within a launched instance of JSW, such that Andy may utilize such functionality from within his JSW instance. Example embodiments of the present disclosure may include receiving an embedded application access share request in response to user interaction with an embedded application user interface displayed in association with the user-accessed application (e.g., a share request associated with Andy clicking a “share” button of the embedded Confluence® page being displayed in association with JSW). Embodiments of the present disclosure may further be configured to access at least a user-accessed application member repository (e.g., access a team member repository of JSW). Embodiments of the present disclosure may further be configured to determine a member share suggestion set comprising one or more user-accessed application member objects (e.g., determine a list of JSW users, such as JSW teammates of Andy, based on the JSW user identifier and/or JSW team identifier of Andy, regardless of whether such JSW teammates have access to Confluence®). Embodiments of the present disclosure may further be configured to generate an embedded application access share interface component comprising the member share suggestion set and output the embedded application access share interface component for rendering to the embedded application user interface (e.g., the embedded Confluence® page). By surfacing suggested first software application users without requiring the user to switch between separate applications or otherwise manually input contact information for non-users of the embedded second software application, the efficiency with which such functionality can be performed is greatly improved. Additionally, overall user experience is improved by helping users to collaborate more seamlessly across products and reducing share friction and tediousness associated with such cross-product sharing, thereby salvaging and otherwise increasing embedded application access share attempts, as well as increasing second software application membership.

Still further embodiments of the present disclosure may be configured to surface information to the embedded application access share interface component indicating which user-accessed application member objects (e.g., which JSW teammates) were identified outside of the embedded application (e.g., which JSW teammates are not Confluence users). For example, a user-accessed application member object (e.g., name of JSW teammate) of a non-user of the embedded application (e.g., a non-Confluence user) may be displayed in association with an embedded application invitation (e.g., “Invite to Confluence”). Further embodiments of the present disclosure may also be configured to surface the software application source of the user-accessed application member object (e.g., “Found in Jira Software”).

Subsequent to one or more user-accessed application member objects being selected by the user from the member share suggestion set of the embedded application access share interface component (e.g., user interaction with the user-accessed application member objects to indicate selection for sharing), embodiments of the present disclosure may be configured to generate an updated embedded application access share interface component removing the member share suggestion set and reflecting the one or more selected user-accessed application member objects. In still some further embodiments, the updated embedded application access share interface component may comprise a message interface component configured to receive textual input for optional inclusion with sharing of the embedded application. In still further embodiments, the updated embedded application access share interface component may comprise a recipient identification completion confirmation interface component configured to receive user interaction (e.g., a “Share” button).

In some embodiments of the present disclosure, an electronic communication is programmatically generated and transmitted to the user(s) corresponding to the one or more selected user-accessed application member objects. For example, an electronic communication may include an embedded application invitation request to become a user or licensee of the embedded application (e.g., Confluence), a name or title of the embedded application instance (e.g., name of the embedded Confluence page), and any optional message included by the first user in sharing the embedded application instance. In some embodiments, once the recipient of the electronic communication joins or otherwise licenses the embedded application, the recipient may be directly linked to the shared embedded application instance so that the recipient may attend to the content that requires their attention.

It should be appreciated that embodiments disclosed herein provide for user-accessed applications and embedded applications in any of a myriad of contexts. In some example contexts, for example, the embedded application and the user-accessed application may be controlled by a single entity or otherwise part of a single suite of software tools. In another context, an embedded application and a user-accessed application may be controlled by separate entities. For example, an entity controlling a user-accessed application may enable access to functionality of an embedded application controlled by another entity for any of a myriad of business reasons (e.g., to increase revenue by incentivizing use of advanced features requiring payment by a user) and/or technical reasons (e.g., to provide access to complementary functionality upon which the embedded application is based). In this regard, it should be appreciated that example embodiments may be configured as described herein to provide interoperability between a user-accessed application and an embedded application in a manner that provides an improvement to the field of interoperable application data management, as described herein.

Accordingly, systems structured in accordance with various embodiments of the present disclosure may provide specific, technical solutions to technical problems faced by existing systems, the details of which are described hereafter.

### Definitions

As used herein, the term “project management and collaboration system” refers to the software platform(s) and associated hardware that is configured to support and maintain a plurality of projects, programs, workflows, tools and all associated functionality. For example, a non-limiting example of a project management and collaboration system may comprise one or more software products such as Jira Software®, Jira Work Management®, or Confluence® by Atlassian®. Example project management and collaboration systems comprise supporting server(s), repositor(ies), and client devices, and in some embodiments, are further configured to engage with internal resources, external resources, internal applications, and/or external applications.

The term “cross-collaboration management server” refers to a software platform and associated hardware that is configured to, inter alia, detect and/or receive embedded application access share request(s), access (and/or direct the access of) a variety of data repositor(ies) (e.g., a user-accessed application team member repository), determine member share suggestion set(s), and generate and/or manage the various interfaces and/or interface components (e.g., embedded application access share interface components) and associated functionality of the project management and collaboration system. For example, in some embodiments, the cross-collaboration management server is configured to generate, output, update and/or otherwise manage embedded application access share interface component(s) and/or the like.

The cross-collaboration management server is accessible via one or more computing devices, is configured to receive various requests (e.g., embedded application access share request(s) and/or the like), and access (and/or direct the access of) one or more data repositories, such as a user-accessed application team member repository. The functionality of the cross-collaboration management server may be provided via a single server or collection of servers having a common functionality, or the functionality of the cross-collaboration management server may be segmented among a plurality of servers or collections of servers (e.g., microservices) performing subsets of the described functionality of the cross-collaboration management server.

As used herein, the term “cross-collaboration management repository” refers to a location, such as a database stored on a memory device, which is accessible by one or more computing devices for retrieval and storage of data associated with the project management and collaboration system. For example, the cross-collaboration management repository may include data associated with the cross-collaboration management server and/or the like. The cross-collaboration management repository may be a dedicated device and/or part of a larger repository. The cross-collaboration management repository may be dynamically updated or may be static. In some embodiments, the cross-collaboration management repository is encrypted in order to limit unauthorized access of data associated with the project management and collaboration system

As used herein, the term “user-accessed application team member repository” refers to a location, such as a database stored on a memory device, which is accessible by one or more computing devices for retrieval and storage of data associated with the project management and collaboration system. For example, the user-accessed application team member repository may include data associated with team members of the user-accessed application (e.g., user-accessed application member objects) and/or the like. The user-accessed application team member repository may be a dedicated device and/or part of a larger repository. The user-accessed application team member repository may be dynamically updated or may be static. In some embodiments, the user-accessed application team member repository is encrypted in order to limit unauthorized access of data associated with the project management and collaboration system.

As used herein, the term “embedded application member repository” refers to a location, such as a database stored on a memory device, which is accessible by one or more computing devices for retrieval and storage of data associated with the project management and collaboration system. For example, the embedded application member repository may include data associated with members of the embedded application and/or the like. The embedded application member repository may be a dedicated device and/or part of a larger repository. The embedded application member repository may be dynamically updated or may be static. In some embodiments, the embedded application member repository is encrypted in order to limit unauthorized access of data associated with the project management and collaboration system.

The term “embedded” with respect to a particular application refers to a combination of functionality and corresponding user interface displayed in association with or otherwise presented from within an instance of a first software application (e.g., a user-accessed application). In some embodiments, such separate applications are associated with a different set of provisioned user accounts and/or dedicated and distinct data repositories for each application, such that functionality made available via embedding is controlled by each of the separate applications from within the user-accessed application as described herein.

The term “executable code base” refers to computer program code stored in one or a plurality of locations that is executed and/or executable via one or more computer devices embodied in hardware, software, firmware, and/or any combination thereof. An executable code base defines at least one particular application to be executed by one or more computing devices. In some embodiments, a memory, storage, and/or other computing device includes and/or otherwise is structured to define any number of separate executable code bases (e.g., a first application and a second application, a user-accessed application and an embedded application, or the like). Alternatively or additionally, in some embodiments, separate executable code bases are embodied by separate computing devices (e.g., a first server embodying a first executable code base and a second server embodying a second executable code base).

The term “user-accessed application” refers to a first executable code base that performs a particular first set of functions and is configured to provide a second set of functions associated with an embedded application embodied by a second executable code base through interaction via a connection associated with the embedded application, such as a data-driven connection. For example, the user-accessed application may embed functions of an embedded application within an integrated interface (e.g., an embedded application user interface displayed in association with a user-accessed application instance) along with native functions of the user-accessed application. The data-driven connection is a configuration and/or mechanism (e.g., a library of one or more application programming interface(s) (APIs) configured for enabling such interaction) by which a user-accessed application is enabled to access embedded app data object(s) and/or associated functionality provided by an embedded application. In some embodiments, the corresponding embedded application user interface is displayed in association with or otherwise presented from within an instance of the user-accessed application. A user-accessed application is associated with a first set of user accounts that are provisioned to enable access to the functionality provided by the user-accessed application.

In some embodiments, the user-accessed application is a project management application or project management-type application which may be a dedicated software program, application, platform, service, web browser, or computer-executable application software programmed or configured to run on a client device which provides the user access to the project management and collaboration system and its associated functionality. In some embodiments, the project management application may include hardware, software, or combinations thereof operating remotely (e.g., on a server). In some embodiments, the project management application is designed to execute on mobile devices, such as tablets or smartphones. For example, in certain embodiments, an app is provided that executes on mobile device operating systems such as iOS® Android®, or Windows®. These platforms typically provide frameworks that allow apps to communicate with one another and with particular hardware and software components of mobile devices. For example, the mobile operating systems named above each provide frameworks for interacting with location services circuitry, wired and wireless network interfaces, user contacts, and other applications. Communication with hardware and software modules executing outside of the app is typically provided via application programming interfaces (APIs) provided by the mobile device operating system.

The term “embedded application” refers to an executable code base that performs a particular second set of functions and is configured to be accessed at least through a user-accessed application associated with a separate executable code base from that of the embedded application. For example, functionality associated with an embedded application may be embedded into an integrated interface comprising functionality of a user-accessed application. In some embodiments, the corresponding embedded application user interface is displayed in association with or otherwise presented from within an instance of the first software application (e.g., a user-accessed application). An embedded application is associated with a second set of user accounts that are provisioned to enable access to the functionality provided by the embedded application. In some embodiments, an embedded application is accessible directly as well as through a user-accessed application. Further details regarding user-accessed applications, embedded applications, data-driven connections, and otherwise provisioning embedded application access are described in commonly-owned U.S. Pat. No. 11,044,348, which was filed as U.S. application Ser. No. 17/090,648 on Nov. 5, 2020, and is entitled “SYSTEM, METHOD, AND COMPUTER PROGRAM PRODUCT FOR IMPROVED EMBEDDED APPLICATION DATA MANAGEMENT”, which patent is incorporated by reference herein in its entirety.

The term “user interface” or “user-accessed application user interface” refers to a graphical user interface of a user-accessed application. In some embodiments, a user-accessed application user interface is configured to enable users to view and engage with one or more project management workspaces (e.g., such as a Jira Software workspace). A user-accessed application user interface is rendered to a client device based on data and instructions provided by the user-accessed application and/or the project management and collaboration system (e.g., cross-collaboration management server). In some embodiments, such data and instructions are facilitated by a dedicated software application running on the client device. In other embodiments, such data and instructions are provided through a web browser running on the client device.

The term “embedded application access share interface component” refers to a user interface element that is rendered to, or as a portion of, a graphical user interface in a project management and collaboration system and is configured to receive user interaction and to display a member share suggestion set comprising one or more user-accessed application member objects, a recipient input field, and/or a message interface component.

The term “embedded application access share request” refers to an electrically generated digital object created by a computing device that indicates that a user has provided an input comprising a request to generate and display an embedded application access share interface component. In some embodiments, the embedded application access share request is associated with a team identifier, a team member identifier, and/or the like. An embedded application access share request may be represented via a temporary code that notifies a recipient (e.g., a server) that a user (e.g., a user of the user-accessed application) has made the request. To provide further context, an embedded application access share request is generated in response to a user interaction with a computing device wherein a user causes the computing device to generate an embedded application access share request. For example, in some embodiments, the user interacts with, for example, a specific actuator button (e.g., “Share”) rendered on a visual display of the computing device in association with the embedded application user interface.

The term “member share suggestion set” refers to a set of suggested user-accessed application member objects identified as potential users to be provided access to the particular embedded application instance.

The term “embedded application invitation request” refers to a portion of a communication generally directed to a user recipient inviting the selected user recipient to become a member or licensee of the embedded application. The invitation request allows access to the embedded application once licensed and generally includes a user engageable link to access the respective embedded application instance once licensed.

The terms “team identifier” or “team ID” refer to one or more items of data by which a team comprising one or more team members may be uniquely identified within a project management and collaboration system. For example, a team identifier may comprise one or more of American Standard Code for Information Interchange (ASCII) text, encryption keys, identification certificates, a pointer, an Internet Protocol (IP) address, a URL, a MAC address, a memory address, or other unique identifier, or combinations thereof.

The terms “team member identifier” or “team member ID” refer to one or more items of data by which a team member may be uniquely identified within a project management and collaboration system. For example, a team member identifier may comprise one or more of ASCII text, encryption keys, identification certificates, a pointer, an IP address, a URL, a MAC address, a memory address, or other unique identifier, or combinations thereof.

The terms “project identifier” or “project ID” refer to one or more items of data by which a project may be uniquely identified within a project management and collaboration system. For example, a project identifier may comprise one or more of ASCII text, encryption keys, identification certificates, a pointer, an IP address, a URL, a MAC address, a memory address, or other unique identifier, or combinations thereof.

The terms “user identifier” or “user ID” refer to one or more items of data by which a user may be uniquely identified within a project management and collaboration system. For example, a user identifier may comprise one or more of ASCII text, encryption keys, identification certificates, a pointer, an IP address, a URL, a MAC address, a memory address, or other unique identifier, or combinations thereof.

The terms “user interaction” or “user engagement” refer to user interaction, via a graphical user interface, with an interface or components thereof. Such user engagement or user interaction with the interface or components thereof can be via a multitude of interactions, such as, but not limited to, “non-keystroke engagement” or “keystroke engagement.” Non-keystroke engagement refers to user interaction in which such user interaction is free from (i.e., excludes) the entering of one or more (e.g., keystroke) characters into a user interface. For example, touch-screen or mouse click engagement are examples of non-keystroke engagement. The term “keystroke engagement” refers to entering of one or more keystrokes into a component of the interface. For example, input of one or more characters (e.g., alphanumeric characters or emojis) into a component of the interface is one example of keystroke engagement.

As used herein, the terms “data,” “content,” “digital content,” “digital content object,” “signal,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

Terms such as “computing,” “determining,” “generating,” and/or similar words are used herein interchangeably to refer to the creation, modification, or identification of data.

The term “computer-readable storage medium” refers to a non-transitory, physical or tangible storage medium (e.g., volatile or non-volatile memory), which may be differentiated from a “computer-readable transmission medium,” which refers to an electromagnetic signal.

The term “client device” and similar terms refer to computer hardware and/or software that is configured to access a service made available by a server. The server is often (but not always) on another computer system, in which case the client device accesses the service by way of a network. Client devices may include, without limitation, smart phones, tablet computers, laptop computers, wearables, personal computers, enterprise computers, and the like.

The terms “database,” “repository,” and/or similar terms used herein interchangeable may refer to a collection of records or data that is stored in a computer-readable storage medium using one or more database types. The term “database type” may refer to a type of database, such as a hierarchical database, network database, relational database (e.g., Aurora, RDS), entity-relationship database, object database (e.g., S3), document database, semantic database, graph database, noSqL database (e.g., DynamoDB), and/or the like.

The term “comprising” means including but not limited to and should be interpreted in the manner it is typically used in the patent context. Use of broader terms such as comprises, includes, and having should be understood to provide support for narrower terms such as “consisting of,” “consisting essentially of,” and “comprised substantially of”.

The phrases “in one embodiment,” “according to one embodiment,” “in some embodiments,” and the like generally mean that the particular feature, structure, or characteristic following the phrase may be included in the at least one embodiment of the present disclosure and may be included in more than one embodiment of the present disclosure. Thus, the particular feature, structure, or characteristic may be included in more than one embodiment of the present disclosure such that these phrases do not necessarily refer to the same embodiment. Further, “based on,” “based at least in part on,” “based at least on,” “based upon,” and/or similar words are used herein interchangeably in an open-ended manner such that they do not indicate being based only on or based solely on the referenced element or elements unless so indicated.

The terms “illustrative,” “example,” “exemplary” and the like are used herein to mean “serving as an example, instance, or illustration” with no indication of quality level. Any implementation described herein as “exemplary” is not necessarily to be construed as preferred or advantageous over other implementations.

The terms “about,” “approximately,” “generally,” “substantially,” or the like, when used with a number, may mean that specific number, or alternatively, a range in proximity to the specific number, as understood by persons of skill in the art field and may be used to refer to within manufacturing and/or engineering design tolerances for the corresponding materials and/or elements as would be understood by the person of ordinary skill in the art, unless otherwise indicated.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such a component or feature may be optionally included in some embodiments, or it may be excluded.

If the specification presents a list, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

The term “set” refers to a collection of one or more items.

The term “plurality” refers to two or more items.

The term “or” is used herein in both the alternative and conjunctive sense, unless otherwise indicated.

### Example System Architecture

Methods, apparatus, and computer program products of the present disclosure may be embodied by any of a variety of computing devices. For example, the method, apparatus, and computer program product of an example embodiment may be embodied by a networked device (e.g., an enterprise platform), such as a server or other network entity, configured to communicate with one or more devices, such as one or more client devices. Additionally, or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, or any combination of the aforementioned devices.

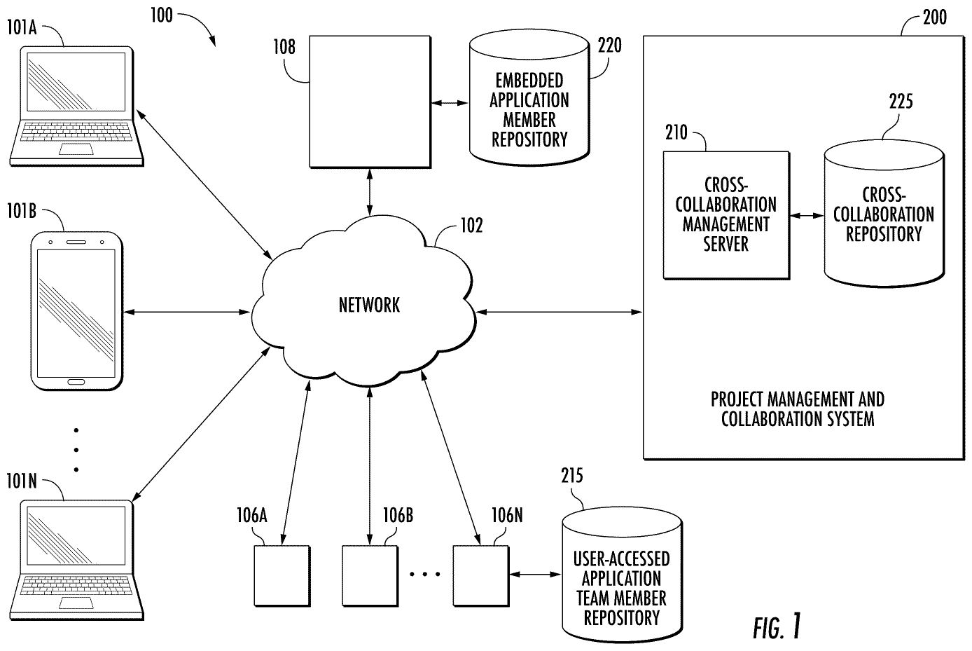

With reference to FIG. 1, an example computing system 100 architecture within which some embodiments of the present disclosure operate is illustrated. The example computing system 100 comprises a project management and collaboration system 200, a plurality of software development tools 106A-106N, one or more collaboration tools 108, and a plurality of client devices 101A-101N, each communicatively connected through a communications network 102. Accordingly, user(s) (e.g., high-level users, business leaders (such as CEO, CFO, VP, etc.), project management (PgM) users, team leaders, team members, etc.) may access the project management and collaboration system 200 via the communications network 102 using one or more of client devices 101A-101N. Project management and collaboration system 200 may comprise a cross-collaboration management server 210 in communication with at least one data repository, such as a user-accessed application team member repository 215, an embedded application member repository 220, and/or cross-collaboration repository 225. Such repository(ies) may be hosted by the cross-collaboration management server 210 or otherwise hosted by devices in communication with the cross-collaboration management server 210.

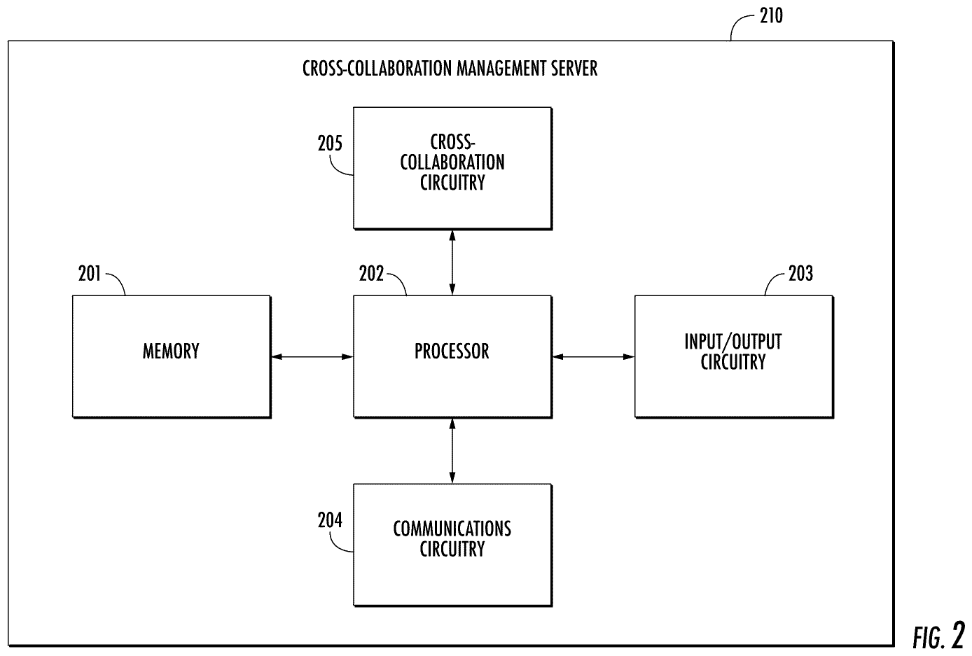

Cross-collaboration management server 210 may include circuitry, networked processors, or the like configured to perform some or all of the cross-collaboration management-based processes described herein and may be any suitable network server and/or other type of processing device. In some embodiments, cross-collaboration management server 210 may determine and transmit commands and instructions for rendering one or more embedded application access share interface components to client devices 101A-101N, using data from, for example, user-accessed application team member repository 215 and/or embedded application member repository 220. In this regard, the cross-collaboration management server 210 may be embodied by any of a variety of devices, for example, the cross-collaboration management server 210 may be embodied as a computer or a plurality of computers. For example, cross-collaboration management server 210 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least the components illustrated in FIG. 2 and described in connection therewith. In some embodiments, cross-collaboration management server 210 may be located remotely from the user-accessed application team member repository 215, embedded application member repository 220, and/or cross-collaboration repository 225, although in other embodiments, the cross-collaboration management server 210 may comprise the user-accessed application team member repository 215, embedded application member repository 220, and/or cross-collaboration repository. The cross-collaboration management server 210 may, in some embodiments, comprise several servers or computing devices performing interconnected and/or distributed functions. Despite the many arrangements contemplated herein, cross-collaboration management server 210 is shown and described herein as a single computing device to avoid unnecessarily overcomplicating the disclosure.

Cross-collaboration management server 210 can communicate with one or more client devices 101A-101N via communications network 102. Communications network 102 may include any one or more wired and/or wireless communication networks including, for example, a wired or wireless local area network (LAN), personal area network (PAN), metropolitan area network (MAN), wide area network (WAN), or the like, as well as any hardware, software and/or firmware required for implementing the one or more networks (e.g., network routers, switches, hubs, etc.). For example, communications network 102 may include a cellular telephone, mobile broadband, long term evolution (LTE), GSM/EDGE, UMTS/HSPA, IEEE 802.11, IEEE 802.16, IEEE 802.20, Wi-Fi, dial-up, and/or WiMAX network. Furthermore, the communications network 102 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the project management and collaboration system 200.

The user-accessed application team member repository 215 may be stored by any suitable storage device configured to store some or all of the information described herein (e.g., memory 201 of the cross-collaboration management server 210 or a separate memory system separate from the cross-collaboration management server 210, such as one or more database systems, backend data servers, network databases, cloud storage devices, or the like provided by another device (e.g., online application or 3rd party provider), such as a Network Attached Storage (NAS) device or devices, or as a separate database server or servers. The user-accessed application team member repository 215 may comprise data received from the cross-collaboration management server 210 (e.g., via a memory 201 and/or processor(s) 202), and the corresponding storage device may thus store this data. The user-accessed application team member repository 215 includes information accessed and stored by the cross-collaboration management server 210 to facilitate the operations of the project management and collaboration system 200. As such, the user-accessed application team member repository 215 may include, for example, without limitation, data associated with team member(s) and/or licensee(s) of the user-accessed application, such as user-accessed application member object(s), team member identifier(s), team identifier(s), project identifier(s), and/or the like.

The embedded application member repository 220 may be stored by any suitable storage device configured to store some or all of the information described herein (e.g., memory 201 of the cross-collaboration management server 210 or a separate memory system separate from the cross-collaboration management server 210, such as one or more database systems, backend data servers, network databases, cloud storage devices, or the like provided by another device (e.g., online application or 3rd party provider), such as a Network Attached Storage (NAS) device or devices, or as a separate database server or servers. The embedded application member repository 220 may comprise data received from the cross-collaboration management server 210 (e.g., via a memory 201 and/or processor(s) 202), and the corresponding storage device may thus store this data. The embedded application member repository 220 includes information accessed and stored by the embedded application member repository 220 to facilitate the operations of the project management and collaboration system 200. As such, the embedded application member repository 220 may include, for example, without limitation, data associated with embedded application member data, user identifier(s), and/or the like.

The cross-collaboration repository 225 may be stored by any suitable storage device configured to store some or all of the information described herein (e.g., memory 201 of the cross-collaboration management server 210 or a separate memory system separate from the cross-collaboration management server 210, such as one or more database systems, backend data servers, network databases, cloud storage devices, or the like provided by another device (e.g., online application or 3rd party provider), such as a Network Attached Storage (NAS) device or devices, or as a separate database server or servers. The cross-collaboration repository 225 may comprise data received from the cross-collaboration management server 210 (e.g., via a memory 201 and/or processor(s) 202), and the corresponding storage device may thus store this data. The cross-collaboration repository 225 includes information accessed and stored by the cross-collaboration management server 210 to facilitate the operations of the project management and collaboration system 200. As such, the cross-collaboration repository 225 may include, for example, without limitation, data associated with cross-collaboration management, such as user-accessed application member object(s), team member identifier(s), team identifier(s), project identifier(s), user identifier(s), and/or the like.

Software development tools 106A-106N may be any one or more underlying software development tools and/or project management tools (e.g., Jira Software®, Jira Services Management®, Jira Work Management®, etc.). In some embodiments, one or more software development tools 106A-106B may be enterprise tools or non-enterprise (e.g., third party) tools. In some non-limiting embodiments, a software development tool 106 is a user-accessed application.

Collaboration tool 108 may be any one or more underlying collaboration tools (e.g., Confluence®). In some embodiments, one or more collaboration tools 108 may be enterprise tools or non-enterprise (e.g., third party) tools. In some non-limiting embodiments, a collaboration tool 108 is an embedded application.

The client devices 101A-101N may be implemented as any computing device as defined above. Electronic data received by the cross-collaboration management server 210 from the client devices 101A-101N may be provided in various forms and via various methods. For example, the client devices 101A-101N may include desktop computers, laptop computers, smartphones, netbooks, tablet computers, wearables, and/or other networked device, that may be used for any suitable purpose in addition to presenting the embedded application access share interface component to a user and otherwise providing access to the project management and collaboration system 200. The depiction in FIG. 1 of “N” client devices is merely for illustration purposes. According to some embodiments, the client devices 101A-101N may be configured to display an interface on a display of the client device for viewing, creating, editing, and/or otherwise interacting with at least one embedded application access share interface component, which may be provided by the embedded application and/or the project management and collaboration system 200.

In embodiments where a client device 101A-101N is a mobile device, such as a smartphone or tablet, the client device 101A-101N may execute an “app” to interact with the project management and collaboration system 200. Such apps are typically designed to execute on mobile devices, such as tablets or smartphones. For example, an app may be provided that executes on mobile device operating systems such as iOS®, Android®, or Windows®. These platforms typically provide frameworks that allow apps to communicate with one another and with particular hardware and software components of mobile devices. The mobile operating systems named above each provide frameworks for interacting with, for example, wired and wireless network interfaces, user contacts, and other applications. Communication with hardware and software modules executing outside of the app is typically provided via application programming interfaces (APIs) provided by the mobile device operating system. Additionally, or alternatively, the client device 101A-101N may interact with the project management and collaboration system 200 via a web browser. As yet another example, the client devices 101A-101N may include various hardware or firmware designed to interface with the project management and collaboration system 200.

### Example Apparatus for Implementing Embodiments of the Present Disclosure

FIG. 2 illustrates an example cross-collaboration management server 210 in accordance with at least some example embodiments of the present disclosure. In accordance with some example embodiments, cross-collaboration management server 210 may include various components, modules, circuitries, or means, some or all of which may be also or instead be included in one or more client device(s) 101A-101N. In accordance with some example embodiments, cross-collaboration management server 210 may be configured, using one or more of the sets of circuitry embodying memory 201, processor 202, input/output circuitry 203, communications circuitry 204, and/or cross-collaboration circuitry 205 to execute and perform the operations described herein. In some embodiments, cross-collaboration circuitry 205 is included in cross-collaboration management server 210 and/or client device 101A, the circuitry configured to facilitate the functionality discussed herein regarding generating, outputting, and/or updating embedded application access share interface component(s) and/or the like. It will be appreciated that while various references are made herein to a “server” or “servers” such references are not intended to implicate monolithic servers. Rather, as will be apparent to one of ordinary skill in the art in view of this disclosure, the operations and functionality attributed to any disclosed server may be performed in a cloud computing environment and thereby completed by multiple servers.

Although the use of the term “circuitry” as used herein with respect to components 201-205 are described in some cases with respect to functional limitations, it should be understood that the particular implementations necessarily include the use of particular hardware configured to perform the functions associated with the respective circuitry as described herein. It should also be understood that certain of these components 201-205 may include similar or common hardware. For example, two sets of circuitry may both leverage use of the same processor(s), network interface(s), storage medium(s), and/or the like to perform their associated functions, such that duplicate hardware is not required for each set of circuitry. The use of the term “circuitry” with respect to components of the apparatuses described herein should therefore be understood to include particular hardware configured to perform the functions associated with the respective components or particular circuitry as described herein.

The term “circuitry” should also be understood, in some embodiments, to include software for configuring the hardware. For example, in some embodiments, “circuitry” may include processing circuitry, storage media, network interfaces, input/output devices, and the like. In some embodiments, such as in examples where circuitry is included with cross-collaboration management server 210, other elements of the cross-collaboration management server 210 may provide or supplement the functionality of particular circuitry. For example, the processor 202 may provide processing functionality, the memory 201 may provide storage functionality, the communications circuitry 204 may provide network interface functionality, and the like.

In some embodiments, the processor 202 (and/or co-processor or any other processing circuitry assisting or otherwise associated with the processor) may be in communication with the memory 201 via a bus for passing information among components of, for example, cross-collaboration management server 210. The memory 201 is non-transitory and may include, for example, one or more volatile and/or non-volatile memories, or some combination thereof. In other words, for example, the memory 201 may be an electronic storage device (e.g., a computer readable storage medium). The memory 201 may be configured to store information, data, content, applications, instructions, or the like, for enabling an apparatus, e.g., cross-collaboration management server 210, to carry out various functions in accordance with example embodiments of the present disclosure.

Although illustrated in FIG. 2 as a single memory, memory 201 may comprise a plurality of memory components. The plurality of memory components may be embodied on a single computing device or distributed across a plurality of computing devices. In various embodiments, memory 201 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 201 may be configured to store information, data, applications, instructions, or the like for enabling cross-collaboration management server 210 to carry out various functions in accordance with example embodiments discussed herein. For example, in at least some embodiments, memory 201 is configured to buffer data for processing by processor 202. Additionally or alternatively, in at least some embodiments, memory 201 is configured to store program instructions for execution by processor 202. Memory 201 may store information in the form of static and/or dynamic information. This stored information may be stored and/or used by cross-collaboration management server 210 during the course of performing its functionalities.

Processor 202 may be embodied in a number of different ways and may, for example, include one or more processing devices configured to perform independently. Additionally or alternatively, processor 202 may include one or more processors configured in tandem via a bus to enable independent execution of instructions, pipelining, and/or multithreading. Processor 202 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 2 as a single processor, in some embodiments, processor 202 comprises a plurality of processors. The plurality of processors may be embodied on a single computing device or may be distributed across a plurality of such devices collectively configured to function as cross-collaboration management server 210. The plurality of processors may be in operative communication with each other and may be collectively configured to perform one or more functionalities of cross-collaboration management server 210 as described herein.

In an example embodiment, processor 202 is configured to execute instructions stored in the memory 201 or otherwise accessible to processor 202. Alternatively or additionally, the processor 202 may be configured to execute hard-coded functionality. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure processor 202 to perform one or more algorithms and/or operations described herein when the instructions are executed. For example, these instructions, when executed by processor 202, may cause cross-collaboration management server 210 to perform one or more of the functionalities of cross-collaboration management server 210 as described herein.

In some embodiments, input/output circuitry 203 may, in turn, be in communication with processor 202 to provide an audible, visual, mechanical, or other output and/or, in some embodiments, to receive an indication of an input. In that sense, input/output circuitry 203 may include means for performing analog-to-digital and/or digital-to-analog data conversions. Input/output circuitry 203 may include support, for example, for a display, touchscreen, keyboard, button, click wheel, mouse, joystick, an image capturing device (e.g., a camera), motion sensor (e.g., accelerometer and/or gyroscope), microphone, audio recorder, speaker, biometric scanner, and/or other input/output mechanisms. Input/output circuitry 203 may comprise a user interface and may comprise a web user interface, a mobile application, a kiosk, or the like. The processor 202 and/or user interface circuitry comprising the processor 202 may be configured to control one or more functions of a display or one or more user interface elements through computer program instructions (e.g., software and/or firmware) stored on a memory accessible to the processor 202 (e.g., memory 201, and/or the like). In some embodiments, aspects of input/output circuitry 203 may be reduced when implemented also or instead as an end-user machine or other type of device designed for complex user interactions (i.e., client device 101). In some embodiments (like other components discussed herein), input/output circuitry 203 may even be eliminated from cross-collaboration management server 210. Alternatively, in some embodiments, at least some aspects of input/output circuitry 203 may be embodied on an apparatus used by a user (e.g., team member, team leader, PgM, and/or the like) that is in communication with cross-collaboration management server 210. Input/output circuitry 203 may be in communication with memory 201, communications circuitry 204, and/or any other component(s), such as via a bus. Although more than one input/output circuitry and/or other component can be included in cross-collaboration management server 210, only one is shown in FIG. 2 to avoid overcomplicating the disclosure (e.g., like the other components discussed herein).

Communications circuitry 204 may be any means such as a device or circuitry embodied in either hardware or a combination of hardware and software that is configured to receive and/or transmit data from/to a network and/or any other device, circuitry, or module in communication with cross-collaboration management server 210. In this regard, the communications circuitry 204 may include, for example, a network interface for enabling communications with a wired or wireless communication network. Communications circuitry 204 may be configured to receive and/or transmit any data that may be stored by memory 201 using any protocol that may be used for communications between computing devices. For example, the communications circuitry 204 may include one or more network interface cards, antennae, transmitters, receivers, buses, switches, routers, modems, and supporting hardware and/or software, and/or firmware/software, or any other device suitable for enabling communications via a network. Additionally, or alternatively, the communication interface may include the circuitry for interacting with the antenna(s) to cause transmission of signals via the antenna(s) or to handle receipt of signals received via the antenna(s). These signals may be transmitted by the cross-collaboration management server 210 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. Communications circuitry 204 may additionally or alternatively be in communication with the memory 201, input/output circuitry 203 and/or any other component of cross-collaboration management server 210, such as via a bus.

In some embodiments, cross-collaboration circuitry 205 may also or instead be included and configured to perform the functionality discussed herein related to generating, outputting, and/or updating embedded application access share interface component(s) and/or the like. Cross-collaboration circuitry 205 includes hardware components and/or software configured to support interface component functionality, features, and/or services of the cross-collaboration management server 210 and/or client device 101A. The cross-collaboration circuitry 205 may utilize processing circuitry, such as the processor 202, to perform its corresponding operations, and may utilize memory 201 to store collected information. The cross-collaboration circuitry 205 may send and/or receive data from user-accessed application team member repository 215, the embedded application member repository 220, and/or the cross-collaboration repository 225. In some implementations, the sent and/or received data may include identifier(s) (e.g., project identifier, team identifier, team member identifier, and/or the like), and associated data that is configured for association with, for example, generating, outputting, and/or updating embedded application access share interface component(s) and/or the like.

It should also be appreciated that, in some embodiments, the cross-collaboration circuitry 205 may include a separate processor, specially configured field programmable gate array (FPGA), or application specific interface circuit (ASIC) to perform its corresponding functions. For example, in some embodiments, some or all of the functionality of cross-collaboration circuitry 205 may be performed by processor 202. In this regard, some or all of the example processes and algorithms discussed herein can be performed by at least one processor 202 and/or cross-collaboration circuitry 205. For example, non-transitory computer readable storage media can be configured to store firmware, one or more application programs, and/or other software, which include instructions and other computer-readable program code portions that can be executed to control processors of the components of cross-collaboration management server 210 to implement various operations, including the examples shown herein. As such, a series of computer-readable program code portions may be embodied in one or more computer program products and can be used, with a device, cross-collaboration management server 210, database, and/or other programmable apparatus, to produce the machine-implemented processes discussed herein. It is also noted that all or some of the information discussed herein can be based on data that is received, generated and/or maintained by one or more components of the cross-collaboration management server 210, client device 101A, etc. In some embodiments, one or more external systems (such as a remote cloud computing and/or data storage system) may also be leveraged to provide at least some of the functionality discussed herein.

As described above and as will be appreciated based on this disclosure, embodiments of the present disclosure may be configured as systems, methods, apparatuses, computing devices, personal computers, servers, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions embodied in the computer-readable storage medium (e.g., computer software stored on a hardware device). Any suitable computer-readable storage medium may be utilized including non-transitory hard disks, CD-ROMs, flash memory, optical storage devices, or magnetic storage devices.

As will be appreciated, any such computer program instructions and/or other type of code may be loaded onto a computer, processor or other programmable apparatus's circuitry to produce a machine, such that the computer, processor, or other programmable circuitry that execute the code on the machine creates the means for implementing various functions, including those described herein in connection with the components of cross-collaboration management server 210.

The computing systems described herein can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

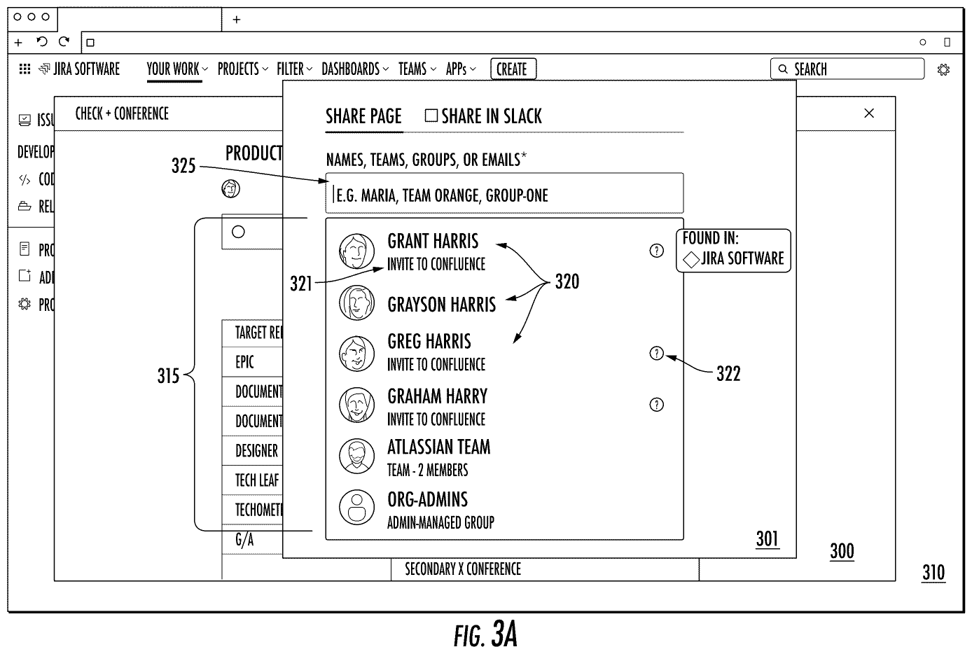

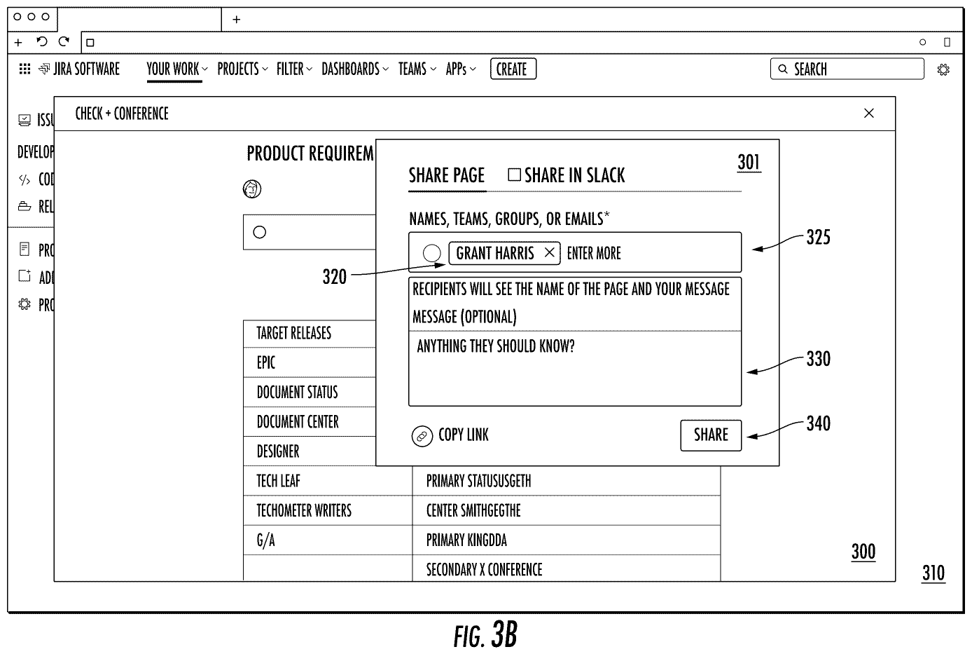

In various embodiments of the present disclosure, an apparatus (e.g., cross-collaboration management server 210) may be configured to generate, output, and/or update an embedded application access share interface component in a project management and collaboration system 200. FIGS. 3A-3B each illustrate an example embedded application access share interface component 301 structured in accordance with various embodiments of the subject disclosure. For example, the depicted embedded application access share interface component 301 of FIG. 3A is an embedded application access share interface component 301 that is rendered to an embedded application user interface 300 that is displayed in association with a user-accessed application (e.g., within a user interface 310 of the first or user-accessed application). The depicted embedded application access share interface component 301 in FIG. 3A comprises a recipient input field 325 configured to receive user input and a member share suggestion set 315, the member share suggestion set 315 comprising one or more user-accessed application member objects 320, thereby exposing a list of potential recipients for sharing the information of the particular embedded application instance. In some embodiments, the recipient input field 325 is configured to receive user input (e.g., keystroke engagement, non-keystroke engagement, etc.) for identifying a potential recipient, such as via name(s) of the potential recipient(s), team name(s) of the potential recipient(s), group name(s) of the potential recipient(s), and/or the like.

The rendering of the member share suggestion set 315 is revealed and/or accessed once a user clicks on or otherwise engages (e.g., touches or selects) the recipient input field 325. Examples of such engagement include, for example, non-keystroke and keystroke engagement. The member share suggestion set 315 is determined as described herein and each user-accessed application member object 320 is configured to be selectable by the user, such selection indicating identification of an intended recipient. For example, the cross-collaboration management server 210 may be configured to detect and/or receive a keystroke input to the recipient input field 325 of the embedded application access share interface component 301. In response to detecting a keystroke engagement to the recipient input field 325, the cross-collaboration management server 210 may determine one or more user-accessed application member objects 320 (e.g., potential recipients) based on at least the detected keystroke engagement. For example, in some embodiments, the cross-collaboration management server 210 may use each keystroke input to the recipient input field 325 and recency data associated with others (e.g., other users that the current user has interacted with recently using the embedded application and/or the user-accessed application) to score, weight, rate, rank, and/or identify each user-accessed application member objects 320 to define, determine, and/or update the member share suggestion set 315. For purposes of illustration and not of limitation, referring to FIG. 3A, in an instance in which the letters “gr” or “ha” are entered into the recipient input field 325 by the user, the cross-collaboration management server 210 may retrieve recency data from the embedded application and/or the user-accessed application and determine one or more user-accessed application member objects 320 (e.g., potential recipients) correlated to such combination of letters. In this regard, a number of user-accessed application member objects 320 beginning with and/or otherwise associated with the letters “gr” or “ha” that may be rendered in the member share suggestion set 315 may be defined by the cross-collaboration management server 210.

In some embodiments, the cross-collaboration management server 210 is configured to query a data repository, such as user-accessed application team member repository 215, for team member data associated with a unique user identifier, team identifier, team member identifier, project identifier, and/or the like. In some embodiments, the cross-collaboration management server 210 is configured to query a data repository, such as embedded application member repository 220, for data (e.g., recency data) associated with a unique user identifier, team identifier, team member identifier, project identifier, and/or the like.

As depicted in FIG. 3A, in some embodiments, one or more visual indicators, icons, or elements may be displayed in association with one or more user-accessed application member objects 320 to surface information indicating which user-accessed application member objects 320 were identified outside of the embedded application. For example, as depicted in association with the first user-accessed application member object 320 displayed in FIG. 3A (e.g., “Grant Harris”), an embedded application invitation 321 (e.g., “Invite to Confluence”) may be rendered, which indicates that the corresponding user-accessed application member object 320 is not currently a user or licensee of the embedded application (e.g., a non-Confluence user). Additionally or alternatively, as depicted in association with the first user-accessed application member object 320 displayed in FIG. 3A (e.g., “Grant Harris”), an information icon 322 may be rendered. The user may interact with the information icon 322 to see additional details associated with the non-user of the embedded application. For example, the user may hover over, click on the “i” to expand, or otherwise interact with the information icon 322 in FIG. 3A in order to expose a further level of information regarding the corresponding user-accessed application member object 320, such as the product or software application source from which the corresponding user-accessed application member object 320 was identified. For example, in the depicted embedded application access share interface component 301 of FIG. 3A, the first user-accessed application member object 320 corresponding to “Grant Harris” was “Found in: Jira Software.” That is, the first user-accessed application member object 320 may have been identified as part of the member share suggestion set 315 based on a unique identifier associated with the user and corresponding to the user-accessed application as described herein (e.g., access at least a user-accessed application team member repository 215 to query team member data associated with a team member identifier to determine a member share suggestion set 315).

In some embodiments, the apparatus (e.g., cross-collaboration management server 210) generates and outputs the embedded application access share interface component 301 for rendering to the embedded application user interface 300 in response to detecting and/or receiving one or more embedded application access share requests. In a non-limiting contextual example, access to an embedded application (e.g., via a data-driven connection) is embedded within a user interface 310 (e.g., a user-accessed application user interface) of the user-accessed application such that once a user interacts with the access to the embedded application, the embedded application user interface 300 may display in a modal experience via the user-accessed application user interface. In other words, the functionality of the embedded application is available to the user directly within the user-accessed application user interface. In some embodiments, it is from user interaction with this embedded application user interface 300 displayed in association with and/or through the user-accessed application (e.g., access to the functionality of the embedded application is provided to the user through the user-accessed application via an established data-driven connection) that generates one or more embedded application access share requests. For example, a user of the user-accessed application accesses the embedded application access share interface component 301 by verbal command, gesture, on-screen dynamics (e.g., soft key), or other user interaction with the computing device, causing the computing device to generate one or more embedded application access share requests. In a non-limiting example, the user interacts with a specific actuator button (e.g., “Share”) rendered on a visual display of the computing device (e.g., client device 101A) in association with the embedded application user interface 300 that, when selected by the user, causes the client device 101A to generate one or more embedded application access share requests. In an example instance wherein the apparatus is a cross-collaboration management server 210, in response to the user clicking or activating the “Share” actuator button displayed in association with the embedded application user interface 300 is displayed in association with and/or through the user-accessed application, the client device 101A generates and transmits a temporary code representative of an embedded application access share request to the cross-collaboration management server 210. In response to the receipt of the embedded application access share request by the cross-collaboration management server 210, the corresponding embedded application access share interface component 301 is generated and caused to be displayed. Such example, however, is for purposes of illustration and not of limitation and other suitable variations of facilitating the generation of an embedded application access share requests are also contemplated by this disclosure as will be apparent to one of ordinary skill in the art.

Additionally or alternatively, the one or more embedded application access share requests comprises any one or more data points or unique identifiers that may be necessary to cull relevant information in order to generate the embedded application access share interface component 301. To provide context, in a non-limiting example, a user may be associated with one or more team member identifiers with respect to the user-accessed application and such user may be accessing an embedded Confluence user interface (e.g., the embedded application user interface 300) via an instance of the user-accessed application (e.g., Jira Software). In some embodiments, the user may have or be associated with a team member identifier corresponding to the current project the user is working on with respect to the user-accessed application (e.g., Jira Software). The embedded application access share request may comprise such unique team member identifier. Other non-limiting examples include project identifier, team identifier, user identifier, and/or the like.

Turning to FIG. 3B, the depicted embedded application access share interface component 301 is an updated embedded application access share interface component 301 structured in accordance with various embodiments of the subject disclosure. For example, subsequent to one or more user-accessed application member objects 320 being selected by the user (e.g., user interaction with a user-accessed application member object 320 to indicate selection for sharing to such corresponding intended recipient) from the member share suggestion set 315 of the embedded application access share interface component 301 depicted in FIG. 3A, the apparatus (e.g., cross-collaboration management server 210) may be configured to generate an updated embedded application access share interface component 301 to remove the member share suggestion set 315 and to reflect such selection of the one or more selected user-accessed application member objects 320. For example, as depicted in FIG. 3B, the non-embedded application user corresponding to the first user-accessed application member object 320 depicted in FIG. 3A, “Grant Harris”, has been selected such that the user-accessed application member object 320 for “Grant Harris” is displayed in the recipient input field 325 of the updated embedded application access share interface component 301. In some embodiments, the recipient input field 325 of the updated embedded application access share interface component 301 is configured to optionally receive user input of one or more additional intended recipients, which may be manually entered and/or further selected from the member share suggestion set 315 (e.g. interaction with the recipient input field 325 may cause the member share suggestion set 315 to be displayed in association with the updated embedded application access share interface component 301). In some embodiments, the user-accessed application member object 320 may be associated with an “x”, as depicted in FIG. 3B, or some other indication that the user may use to remove the selected user-accessed application member object 320 from the recipient input field 325.

In some further embodiments, the updated embedded application access share interface component 301 may comprise a message interface component 330, as depicted in FIG. 3B, the message interface component 330 configured to receive textual input for optional inclusion with sharing of the corresponding embedded application information.

In some embodiments, the updated embedded application access share interface component 301 may comprise a share confirmation interface component 340 configured to receive user interaction via a recipient identification completion confirmation interface component (e.g., a “Share” button) for confirming completion of the identification of intended recipients.

Such depicted examples of embedded application access share interface components are for purposes of illustration and not of limitation and other suitable variations of depicting the various embedded application access share interface components are also contemplated by this disclosure as will be apparent to one of ordinary skill in the art.

### Example Operations Performed

Having described example apparatuses and systems and exemplary circuitry in accordance with various embodiments of the present disclosure, example process of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof. It will further be appreciated that the example apparatuses, systems, devices, and/or computer program products may proceed to generate, output, and/or update embedded application access share interface components and/or the like in a project management and collaboration system 200 in a number of different ways.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

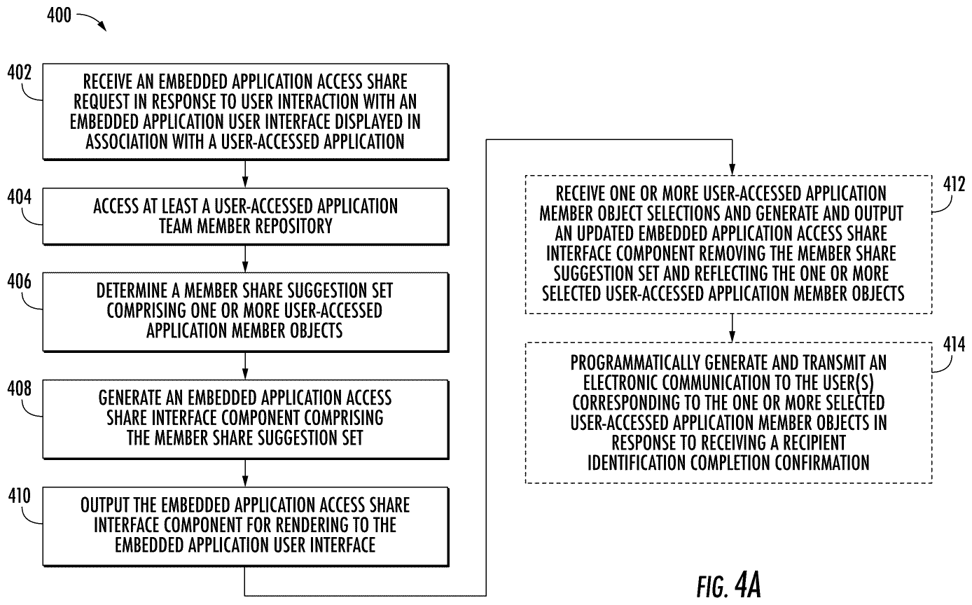

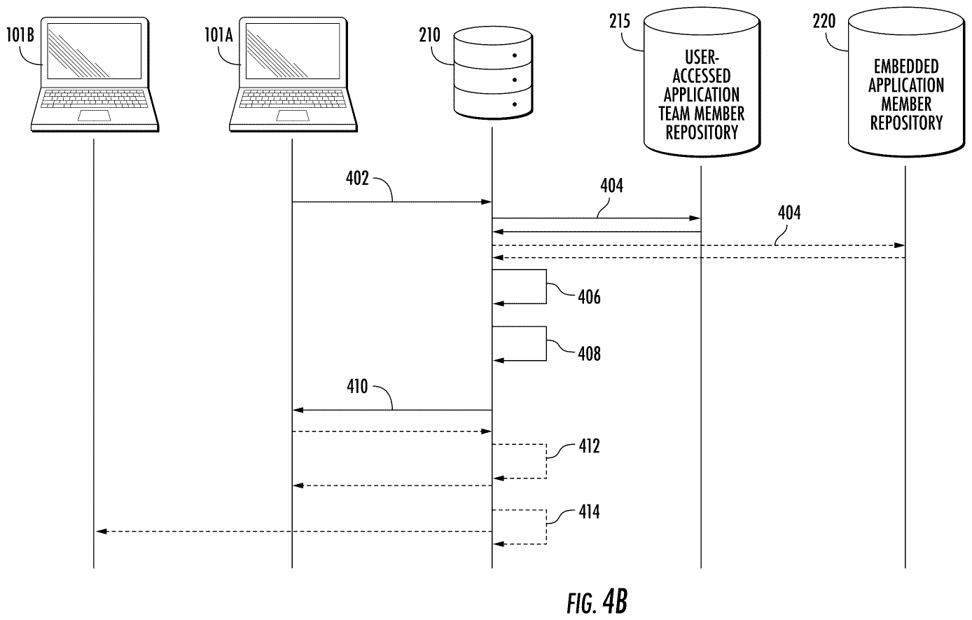

FIG. 4A is a flowchart broadly illustrating a series of operations or process blocks that are executed or performed to output an embedded application access share interface component for rendering to an embedded application user interface displayed in association with a user-accessed application in accordance with some example embodiments of the present disclosure. In some embodiments, the method 400 is embodied by computer program code stored on a non-transitory computer-readable storage medium of a computer program product configured for execution to perform the process as depicted and described. In this regard, in some such embodiments, the cross-collaboration management server 210 is specially configured by computer-coded instructions (e.g., computer program instructions) stored thereon, for example in the memory 201 and/or another component depicted and/or described herein and/or otherwise accessible to the cross-collaboration management server 210, for performing the operations as depicted and described. Alternatively, or additionally, in some embodiments, the method 400 is performed by one or more specially configured computing devices, such as the cross-collaboration management server 210 alone or in communication with one or more other component(s), device(s), system(s), and/or the like. For purposes of simplifying the description, the method 400 is described as performed by and from the perspective of the cross-collaboration management server 210. In this regard, performance of the operations may invoke one or more of memory 201, processor 202, input/output circuitry 203, communications circuitry 204, and/or cross-collaboration circuitry 205.

In the embodiment illustrated in FIG. 4A, the flowchart illustrates method 400 which begins at block 402, which includes receiving an embedded application access share request. For example, the cross-collaboration management server 210 may include means, such as the processor 202, communications circuitry 204, cross-collaboration circuitry 205, or the like, for receiving an embedded application access share request. In some embodiments, the embedded application access share request is received in response to user interaction with an embedded application user interface displayed in association with a user-accessed application at a client device. In still further embodiments, the embedded application access share request is associated with one or more unique identifiers, such as a project identifier, a team identifier, a team member identifier, a user identifier, and/or the like. In a non-limiting contextual example, a user may be associated with one or more team member identifiers with respect to the user-accessed application (e.g., Jira Software) and such user may be accessing an embedded Confluence user interface (e.g., the embedded application access user interface) via an instance of the user-accessed application (e.g., Jira Software). In some embodiments, the user may have or be associated with a team member identifier corresponding to the current project the user is working on with respect to the user-accessed application (e.g., Jira Software). The embedded application access share request may comprise such unique team member identifier.

At block 404, the cross-collaboration management server 210 includes means, such as the memory 201, processor 202, input/output circuitry 203, communications circuitry 204, and/or cross-collaboration circuitry 205, or a combination thereof, to access at least a user-accessed application team member repository. In some embodiments, the cross-collaboration management server 210 may also access an embedded application member repository.

At block 406, the method 400 further includes determining a member share suggestion set comprising one or more user-accessed application member objects. For example, the cross-collaboration management server 210 may include means, such as the processor 202, communications circuitry 204, cross-collaboration circuitry 205, or the like, for determining a member share suggestion set comprising one or more user-accessed application member objects. For example, in some embodiments, block 406 may include the cross-collaboration management server 210 generating a query that is submitted to the user-accessed application team member repository accessed in block 404. Such query may be based on, for example, a team member identifier, a team identifier, a user identifier, a project identifier, and/or the like associated with the embedded application access share request. In such embodiments, the one or more user-accessed application member objects returned by the query may form the member share suggestion set. In other words, in some embodiments, determining a member share suggestion set may comprise generating a query based on at least one of the one or more identifiers associated with the user-accessed application, submitting the query to the user-accessed application team member repository, and assigning the one or more user-accessed application member objects returned by the query to the member share suggestion set.

Determining a member share suggestion set may additionally comprise generating and submitting a query to one or more other data repositories. For example, in some embodiments, block 406 may include the cross-collaboration management server 210 additionally generating a query that is submitted to an embedded application member repository, which is distinct from the user-accessed application team member repository. In other words, in some further embodiments, determining a member share suggestion set may additionally comprise generating a second query based on at least one identifier associated with the embedded application, submitting the second query to the embedded application member repository, and assigning the one or more embedded application member objects returned by the query to the member share suggestion set.

In some embodiments, one or more machine learning models designed to leverage artificial intelligence may be used in connection with the determination of the one or more user-accessed application member objects of a member share suggestion set. For example, in determining the member share suggestion set 315, the cross-collaboration management server 210 may include means, such as the processor 202, communications circuitry 204, cross-collaboration circuitry 205, or the like, to draw from a range of information sources that can be supplied to the machine learning model(s) in order to make contextual suggestions or predictions as to a member share suggestion set 315. For example, any one or more of the data described herein (e.g., team member data, team identifiers, team member identifiers, user identifiers, project identifiers, and/or the like) and correlations thereof can be used in connection with the machine learning model. Moreover, in some embodiments, the machine learning based model employed by the apparatus can be trained using such team member data, team identifiers, team member identifiers, user identifiers, project identifiers, and/or the like. For example, in some embodiments, the apparatus (e.g., via cross-collaboration circuitry 205) implements an unsupervised learning structure, a supervised learning structure, a reinforcement learning structure, a deep learning structure, and/or the like for programmatically determining correlations of the varied data and data formats to make contextual suggestions or predictions as to at least the member share suggestion set 315.

At block 408, the cross-collaboration management server 210 includes means, such as the memory 201, processor 202, input/output circuitry 203, communications circuitry 204, and/or cross-collaboration circuitry 205, or a combination thereof, to generate an embedded application access share interface component comprising the member share suggestion set.

At block 410, the cross-collaboration management server 210 includes means, such as the memory 201, processor 202, input/output circuitry 203, communications circuitry 204, and/or cross-collaboration circuitry 205, or a combination thereof, to output the embedded application access share interface component for rendering to the embedded application user interface, for example, as depicted in FIG. 3A. In some embodiments, at least one of the user-accessed application member objects is caused to be rendered in association with an embedded application invitation, indicating that the corresponding user-accessed application member object is not a member, user, or licensee of the embedded application. In some embodiments, at least one of the user-accessed application member objects is caused to be rendered in association with an information icon. In still further embodiments, the cross-collaboration management server 210 includes means, such as the memory 201, processor 202, input/output circuitry 203, communications circuitry 204, and/or cross-collaboration circuitry 205, or a combination thereof, may be configured to receive a user interaction, such as a hover user interaction, corresponding to the information icon. In still further embodiments, the cross-collaboration management server 210 may be configured to output an informational interface component configured to be rendered to the embedded application access share interface component in association with the information icon, the informational interface component comprising product or software application source data for the corresponding user-accessed application member object (e.g., identify the product or software application source from which the intended recipient was identified).

At optional block 412, the cross-collaboration management server 210 includes means, such as the memory 201, processor 202, input/output circuitry 203, communications circuitry 204, and/or cross-collaboration circuitry 205, or a combination thereof, to optionally receive one or more user-accessed application member object selections from the client device and generate and output an updated embedded application access share interface component removing the member share suggestion set and reflecting the one or more selected user-accessed application member objects.

At optional block 414, the cross-collaboration management server 210 includes means, such as the memory 201, processor 202, input/output circuitry 203, communications circuitry 204, and/or cross-collaboration circuitry 205, or a combination thereof, to optionally programmatically generate and transmit an electronic communication to the user(s) corresponding to the one or more selected user-accessed application member objects in response to receiving a recipient identification completion confirmation (e.g., clicking “Share” in the updated embedded application access share interface component) from the client device. For example, an electronic communication may include an embedded application invitation request to become a user or licensee of the embedded application (e.g., Confluence), a name or title of the embedded application instance (e.g., name of the embedded Confluence page), and any optional message included by the first user in sharing the embedded application instance. In some embodiments, once the recipient of the electronic communication joins or otherwise licenses the embedded application, the recipient may be directly linked to the shared embedded application instance so that the recipient may attend to the content that requires their attention.

FIG. 4B is a signal diagram of an example data flow represented by method 400. That is, FIG. 4B illustrates an example signal diagram illustrating data flow interactions between a first client device, a cross-collaboration management server, a first repository, and optionally a second client device and a second repository when outputting an embedded application access share interface component in accordance with one embodiment. Method 400 is described as being performed by a client device 101A, a cross-collaboration management server 210, a user-accessed application team member repository 215, and optionally a second client device 101B and optionally an embedded application member repository 220. These may be similar to those previously discussed with regards to FIG. 1.

FIGS. 4A and 4B thus illustrate flowcharts and signal diagrams describing the operation of apparatuses, methods, systems, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 201 of the cross-collaboration management server 210 and executed by a processor 202 of the cross-collaboration management server 210. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

Thus, particular embodiments of the subject matter have been described. While this specification contains many specific implementation details, these should not be construed as limitations on the scope of the present disclosure or of what may be claimed, but rather as description of features specific to particular embodiments of present disclosure. Other embodiments are within the scope of the following claims. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. Any operational step shown in broken lines in one or more flow diagrams illustrated herein are optional for purposes of the depicted embodiment.

In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

### CONCLUSION

Many modifications and other embodiments of the present disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus for outputting an embedded application access share interface component in a project management and collaboration system, the apparatus comprising at least one processor, and at least one memory including program code, the at least one memory and the program code configured to, with the at least one processor, cause the apparatus to at least:
receive an embedded application access share request in response to user interaction with an embedded application user interface displayed in association with a user-accessed application, the embedded application user interface corresponding to an embedded application embedded in the user-accessed application;
access at least a user-accessed application team member repository;
determine, via the at least one processor, a member share suggestion set comprising one or more user-accessed application member objects;
generate an embedded application access share interface component comprising the member share suggestion set; and
output the embedded application access share interface component for rendering to the embedded application user interface.

2. The apparatus of claim 1, wherein the embedded application access share request comprises one or more identifiers associated with the user-accessed application.

3. The apparatus of claim 2, wherein the one or more identifiers comprises at least one of a project identifier, a team identifier, or a team member identifier.

4. The apparatus of claim 2, wherein determining the member share suggestion set comprises:
generating a query based on at least one of the one or more identifiers associated with the user-accessed application;
submitting the query to the user-accessed application team member repository; and
assigning the one or more user-accessed application member objects returned by the query to the member share suggestion set.

5. The apparatus of claim 4, wherein determining the member share suggestion set further comprises:
generating a second query based on at least one identifier associated with the embedded application;
submitting the second query to an embedded application member repository; and
assigning one or more embedded application member objects returned by the query to the member share suggestion set.

6. The apparatus of claim 1, wherein the user-accessed application and the embedded application define separate executable code bases.

7. The apparatus of claim 6, wherein the user-accessed application defines a first executable code base that performs a particular first set of functions and is configured to provide a second set of functions associated with the embedded application embodied by a second executable code base.

8. The apparatus of claim 1, wherein the at least one memory and the program code are further configured to, with the at least one processor, cause the apparatus to at least:
receive one or more user-accessed application member object selections;
generate an updated embedded application access share interface component removing the member share suggestion set and causing display of the one or more selected user-accessed application member objects; and
output the updated embedded application access share interface component for rendering to the embedded application user interface.

9. The apparatus of claim 8, wherein the at least one memory and the program code are further configured to, with the at least one processor, cause the apparatus to at least:
programmatically generate and transmit an electronic communication to one or more client devices, each client devices associated with a user corresponding to at least one of the one or more selected user-accessed application member objects.

10. The apparatus of claim 1, wherein at least one of the one or more user-accessed application member objects is caused to be rendered in association with an embedded application invitation.

11. The apparatus of claim 1, wherein at least one of the one or more user-accessed application member objects is caused to be rendered in association with an information icon.

12. The apparatus of claim 11, wherein the at least one memory and the program code are further configured to, with the at least one processor, cause the apparatus to at least:
receive a hover user interaction corresponding to the information icon; and
output an informational interface component configured to be rendered to the embedded application access share interface component in association with the information icon, the informational interface component comprising product or software application source data for the corresponding user-accessed application member object.

13. A computer-implemented method for outputting an embedded application access share interface component in a project management and collaboration system, the method comprising:
receiving an embedded application access share request in response to user interaction with an embedded application user interface displayed in association with a user-accessed application, the embedded application user interface corresponding to an embedded application embedded in the user-accessed application, wherein the user-accessed application and the embedded application define separate executable code bases;
accessing at least a user-accessed application team member repository;
determining a member share suggestion set comprising one or more user-accessed application member objects;
generating an embedded application access share interface component comprising the member share suggestion set; and
outputting the embedded application access share interface component for rendering to the embedded application user interface.

14. The method of claim 13, wherein the embedded application access share request comprises one or more identifiers associated with the user-accessed application.

15. The method of claim 14, wherein the one or more identifiers comprises at least one of a project identifier, a team identifier, or a team member identifier.

16. The method of claim 14, wherein determining the member share suggestion set comprises:
generating a query based on at least one of the one or more identifiers associated with the user-accessed application;
submitting the query to the user-accessed application team member repository; and
assigning the one or more user-accessed application member objects returned by the query to the member share suggestion set.

17. The method of claim 16, wherein determining the member share suggestion set further comprises:
generating a second query based on at least one identifier associated with the embedded application;
submitting the second query to an embedded application member repository; and
assigning one or more embedded application member objects returned by the query to the member share suggestion set.

18. The method of claim 13, wherein the user-accessed application defines a first executable code base that performs a particular first set of functions and is configured to provide a second set of functions associated with the embedded application embodied by a second executable code base.

19. The method of claim 13, the method further comprising:
receiving one or more user-accessed application member object selections;
generating an updated embedded application access share interface component removing the member share suggestion set and causing display of the one or more selected user-accessed application member objects; and
outputting the updated embedded application access share interface component for rendering to the embedded application user interface.

20. A computer program product, stored on a non-transitory computer readable storage medium, comprising instructions that when executed by one or more processors, cause the one or more processors to:
receive an embedded application access share request in response to user interaction with an embedded application user interface displayed in association with a user-accessed application, the embedded application user interface corresponding to an embedded application embedded in the user-accessed application, wherein the embedded application access share request comprises one or more identifiers associated with the user-accessed application;
access at least a user-accessed application team member repository, based at least in part on the one or more identifiers associated with the user-accessed application;
determine a member share suggestion set comprising one or more user-accessed application member objects;
generate an embedded application access share interface component comprising the member share suggestion set; and
output the embedded application access share interface component for rendering to the embedded application user interface.
